(19) United States
(12) Patent Application Publication
(10) Pub. No.: US 2003/0118339 A1
(43) Pub. Date: Jun. 26, 2003

(54) Tripod having a device for energizing camera

(76) Inventors: Chia Chung Yu, Chong Ho City (TW); Yu Chih Tung, Chong Ho City (TW)

Correspondence Address: Chia Chung YU, P.O. Box 10-69, Chong Ho, Taipei, 235, TW

(21) Appl. No.: 10/029,063

(22) Filed: Dec. 20, 2001

(51) Int. Cl. G03B 17/00

(52) U.S. Cl. 396/428

(57) ABSTRACT

A tripod device includes a coupling device disposed on a socket of the tripod for supporting a camera, and one or more batteries received in the coupling device for selectively energizing the camera when the the batteries of the camera have been consumed or are damaged. The coupling device includes a housing having fastener for securing to the camera, and a casing having a channel for receiving the fastener, and a lateral groove for receiving a knob which may rotate the fastener. The batteries may be coupled to the other electric energy sources of such as the vehicles.

### BACKGROUND OF THE INVENTION

1. Field of the Invention

The present invention relates to a tripod, and more particularly to a tripod assembly having a coupling device for supporting and energizing cameras.

2. Description of the Prior Art

Typical tripods may be used for supporting cameras thereon, and the cameras may comprise one or more batteries engaged therein for energizing the cameras. However, the tripod may not be used for energizing the cameras.

The present invention has arisen to mitigate and/or obviate the afore-described disadvantages of the conventional cameras.

### SUMMARY OF THE INVENTION

The primary objective of the present invention is to provide a tripod assembly including a coupling device for supporting and energizing cameras.

In accordance with one aspect of the invention, there is provided a tripod assembly comprising a tripod assembly for supporting a camera, the tripod assembly comprising a tripod body, a coupling device disposed on the tripod body for supporting the camera, and at least one battery received in the coupling device for selectively energizing the camera when the the batteries of the camera body have been consumed or are out of energy or are damaged.

The tripod body includes a socket provided thereon, the coupling device includes a housing having a latch for engaging with the socket and for securing the coupling device onto the tripod body.

The coupling device includes a fastener provided thereon for securing to the camera. The coupling device includes a casing having a channel formed therein for receiving the fastener, and having a lateral groove communicating with the channel of the casing for receiving a knob.

A device may further be provided for coupling the battery to the camera. Another device may further be provided for coupling the battery to an electric energy source, such as the electric energy source of the vehicles or of the family buildings.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a tripod assembly in accordance with the present invention;

FIG. 2 is a bottom perspective view of a coupling device of the tripod assembly;

FIG. 3 is an upper perspective view of the coupling device of the tripod assembly;

FIG. 4 is a top plan view of the coupling device of the tripod assembly;

FIG. 5 is an exploded view of the coupling device of the tripod assembly; and

FIGS. 6 and 7 are partial exploded views illustrating the operation of the coupling device of the tripod assembly.

### DETAILED DESCRIPTION OF THE PREFERRED EMBODIMENT

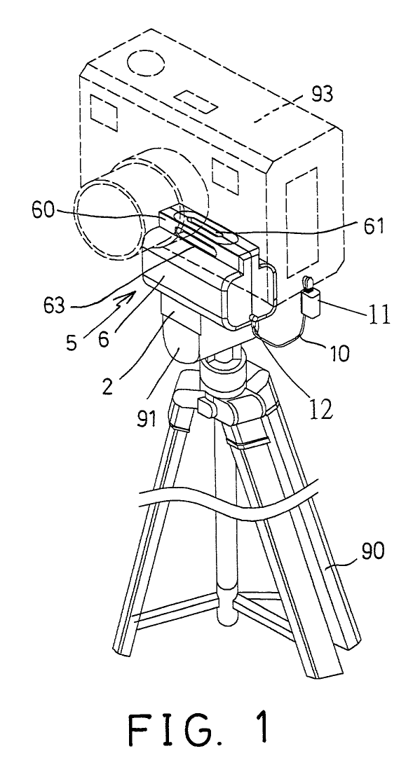

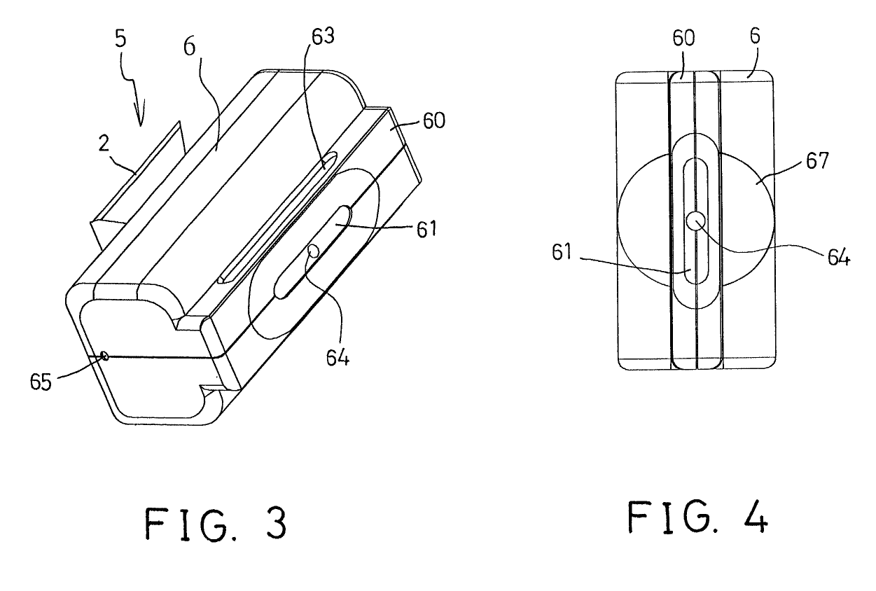

Referring to the drawings, and initially to FIGS. 1-4, a tripod assembly in accordance with the present invention comprises a tripod body 90 including a typical socket 91 provided on top thereof for coupling to the cameras, such as the photo cameras, the digital photo cameras, the video cameras, the digital video camera recorders, etc. The tripod assembly further includes a coupling device 5 having a housing 6 and having a latch 2 disposed or provided on the bottom of the housing 6 for attaching or securing to the socket 91 of the tripod body 90.

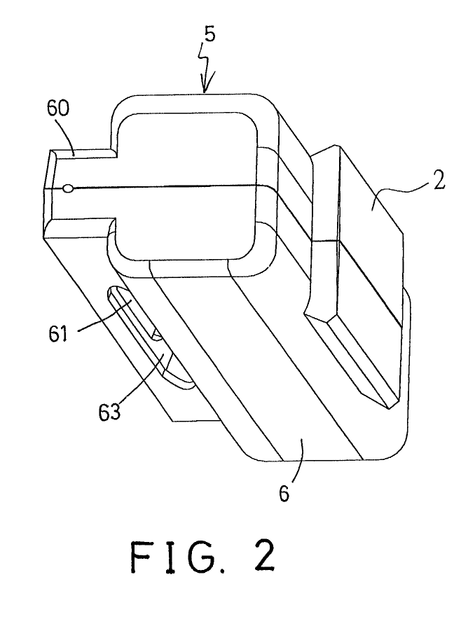

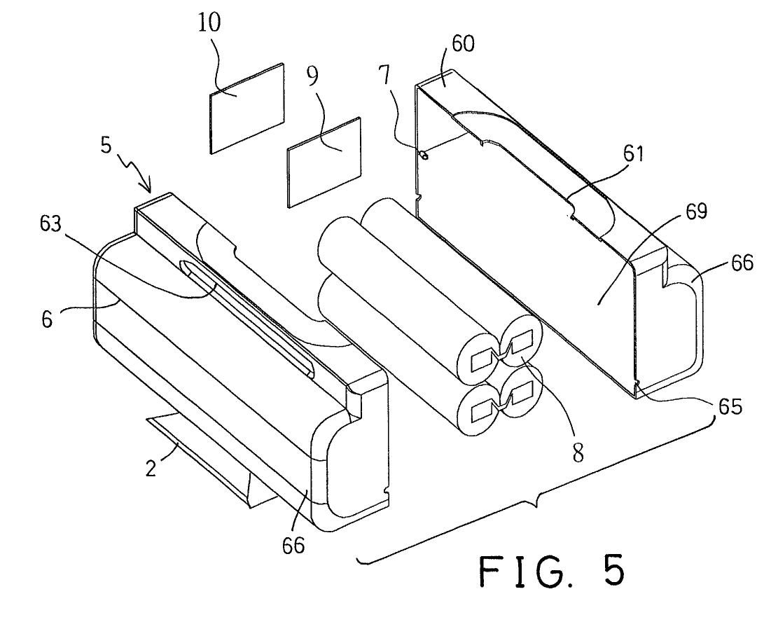

As best shown in FIGS. 2-5, the housing 6 includes a casing 60 formed or provided on top thereof, and includes a channel 61 formed in the casing 60, and includes one or more lateral grooves 63 formed in the casing 60 and communicating with the channel 61 of the casing 60, A fastener 64 may engage through the channel 61 of the casing 60 and may be threaded with the camera body 93 for detachably adjustably securing the camera body 93 onto the housing 6 of the coupling device 5. For example, the fastener 64 may include a control knob 67 (FIG. 4) rotatably and slidably received in the lateral groove 63 of the casing 60 for rotating the fastener 64.

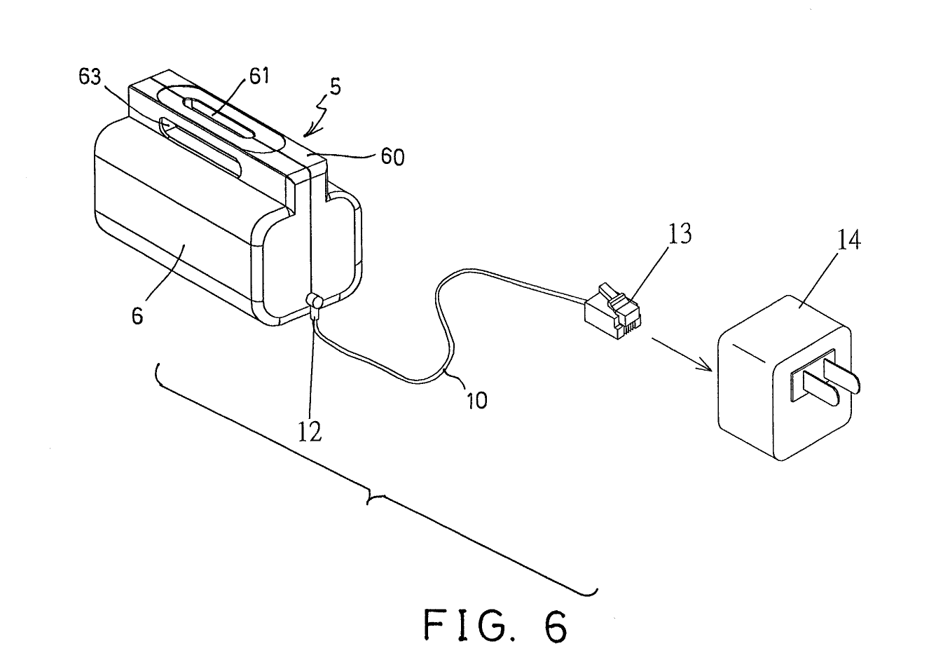

As best shown in FIG. 5, the housing 6 may include two housing members 66 secured together with fasteners, adhesive materials, or by welding processes, and may include a chamber 69 formed therein or formed in the housing members 66 for receiving one or more circuit boards 9, 10 and one or more batteries 8 therein. The housing 6 includes an orifice 65 formed therein for receiving or plugging with a plug 12 (FIGS. 1, 6, 7), which may be coupled to the batteries 8 or the circuit boards 9, 10. An indicating light 7 may further be provided and coupled to the batteries 8 or the circuit boards 9, 10 for generating an indicating or warning light.

In operation, as shown in FIG. 1, the latch 2 of the housing 6 may be secured onto the socket 91 of the tripod body 90. The camera body 93 may be secured on the casing 60 with the fastener 64. The batteries 8 or the circuit boards 9, 10 may be coupled to the camera body 93 with the plug 12, a cable 10, and/or an adapter or a transformer 11, for selectively energizing the camera body 93 which the batteries of the camera body 93 have been consumed or are out of energy or are damaged.

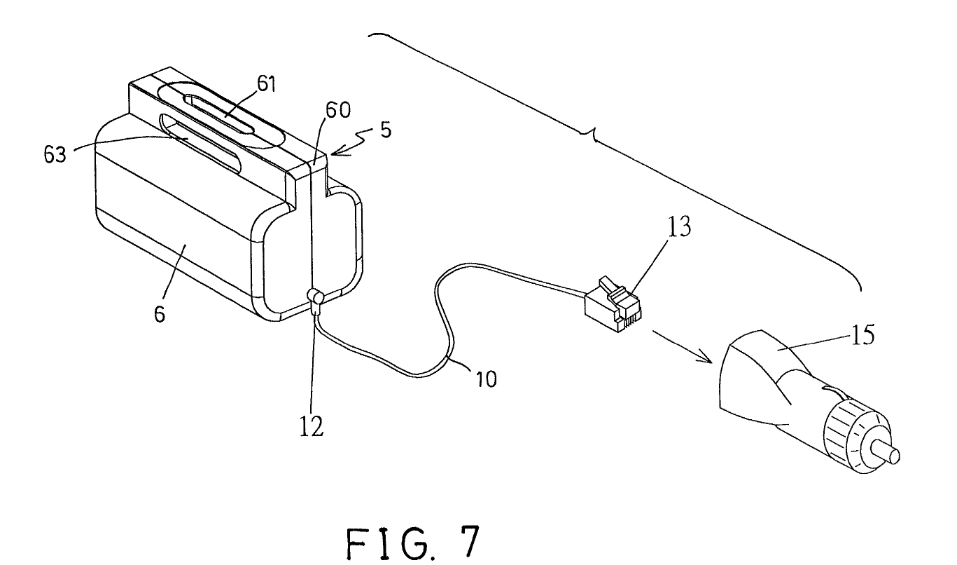

As shown in FIGS. 6 and 7, the housing 6 of the coupling device 5 may also be coupled to a plug 13 with the cable 10 and and the plug 12, for coupling to the electric energy source of the vehicles via another plug 15 (FIG. 7), or may be coupled to an adapter or another plug 14 (FIG. 6) for coupling to the other electric energy sources, and for charging the batteries 8.

It is to be noted that various kinds of camera bodies 93, such as the photo cameras, the digital photo cameras, the video cameras, the digital video camera recorders, etc., may be attached or secured onto the housing 6 of the coupling device 5, and may be selectively energized by the batteries 8.

Accordingly, the tripod assembly in accordance with the present invention includes a handle device that may be used for supporting and energizing cameras.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tripod assembly for supporting a camera, said tripod assembly comprising:
a tripod body,
a coupling device disposed on said tripod body for supporting the camera, and
at least one battery received in said coupling device for selectively energizing the camera.

2. The tripod assembly according to claim 1, wherein said tripod body includes a socket provided thereon, said coupling device includes a housing having a latch for engaging with said socket and for securing said coupling device onto said tripod body.

3. The tripod assembly according to claim 1, wherein said coupling device includes a fastener provided thereon for securing to the camera.

4. The tripod assembly according to claim 3, wherein said coupling device includes a casing having a channel formed therein for receiving said fastener, and having a lateral groove communicating with said channel of said casing for receiving a knob.

5. The tripod assembly according to claim 1 further comprising means for coupling said at least one battery to the camera.

6. The tripod assembly according to claim 1 further comprising means for coupling said at least one battery to an electric energy source.
